(19) United States
(12) Patent Application Publication
(10) Pub. No.: US 2015/0107835 A1
(43) Pub. Date: Apr. 23, 2015

(54) WELL TREATMENT WITH SHAPESHIFTING PARTICLES

(71) Applicant: Schlumberger Technology Corporation, Sugar Land, TX (US)

(72) Inventors: Mohan Panga, Novosibirsk (RU); Dan Fu, Kuala Lumpur (MY)

(73) Assignee: Schlumberger Technology Corporation, Sugar Land, TX (US)

(21) Appl. No.: 14/056,665

(22) Filed: Oct. 17, 2013

(51) Int. Cl. C09K 8/80; E21B 43/24; E21B 43/267

(52) U.S. Cl. CPC C09K 8/805; E21B 43/267; E21B 43/24
USPC 166/280.1; 166/105; 507/200

(57) ABSTRACT

Well treatment with shapeshifting particles. Methods, treatment fluids and systems utilizing shapeshifting particles are disclosed. One method relates to the injection of the shapeshifting particles into a fracture, and changing a conformation of the shapeshifting particles to improve conductivity. A treatment fluid comprises the shapeshifting particles dispersed in a carrier fluid, and a system comprises a unit to supply the treatment fluid, a pump system to inject the treatment fluid into the fracture and a triggering system to change the conformation of the shapeshifting particles.

### RELATED APPLICATION

None.

### BACKGROUND

The statements in this section merely provide background information related to the present disclosure and may not constitute prior art.

Fracturing is used to create conductive pathways in a subterranean formation and increase fluid flow between the formation and the wellbore. A fracturing fluid is injected into the wellbore passing through the subterranean formation. A propping agent (proppant) is injected into the fracture to prevent fracture closure and, thereby, to provide improved extraction of extractive fluids, such as oil, gas or water.

The proppant maintains the distance between the fracture walls in order to create conductive channels in the formation. The pulsed injection of alternating proppant-free and fiber-stabilized, proppant-laden slugs into the fracture has been used to obtain a heterogeneous distribution of proppant particles into a channels and pillars configuration, which can improve the conductivity in the fracture. Accordingly, there is a demand for further improvements in this area of technology.

### SUMMARY

In embodiments according to the disclosure herein, methods, treatment fluids and well treatment systems relate to a treatment fluid comprising shapeshifting particles dispersed in a carrier fluid. In embodiments, the shapeshifting particles have a first set of spatial dimensions corresponding to a first conformation at a first set of conditions and a second set of spatial dimensions corresponding to a second conformation at a second set of conditions, wherein the second set of spatial dimensions comprises at least one dimensional characteristic or aspect ratio that is substantially different than the corresponding dimensional characteristic or aspect ratio of the first conformation.

In some embodiments, hydraulically interconnected channels are formed between proppant clusters in a fracture by shifting the shape of the shapeshifting particles to displace the proppant particles into clusters, for example, by injecting a mixture of proppant and shapeshifting particles into the wellbore at the first conformation, and changing an environment of the shapeshifting particles after placement in the fracture to change their conformation to facilitate differentially moving, e.g., pushing and/or pulling, the proppant particles, aggregating the proppant particles into clusters and/or forming conductive channels between the clusters.

### BRIEF DESCRIPTION OF THE DRAWINGS

These and other features and advantages will be better understood by reference to the following detailed description when considered in conjunction with the accompanying drawings.

FIG. 1 illustrates a pentamodal Apollonian particle packing model based on the Descartes circle theorem involving mutually tangent circles, according to some embodiments of the current application.

FIG. 2 schematically shows elongated shapeshifting fibers shapeshifted into a tighter ball-like structure.

FIG. 3 schematically shows a mixture of elongated shapeshifting fibers and proppant where the fibers are shapeshifted to aggregate the proppant into a tighter ball-like structure.

FIG. 4 schematically shows a mixture of elongated shapeshifting fibers and proppant where the fibers are shapeshifted to aggregate the proppant into a tighter ball-like structure, forming pillar-like structures inside hydraulic fractures.

FIG. 5A shows a dense fiber-proppant structure with uniformly distributed proppant and/or voids under a first set of conditions;

FIG. 5B shows the fiber-proppant structure of FIG. 5A under a second set of conditions with voids forming a network of channels between islands, formed by shrunken fibers, containing proppant particles.

### DETAILED DESCRIPTION

For the purposes of promoting an understanding of the principles of the disclosure, reference will now be made to some illustrative embodiments of the current application. Like reference numerals used herein refer to like parts in the various drawings. Reference numerals without suffixed letters refer to the part(s) in general; reference numerals with suffixed letters refer to a specific one of the parts.

As used herein, “embodiments” refers to non-limiting examples of the application disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Moreover, the schematic illustrations and descriptions provided herein are understood to be examples only, and components and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

It should be understood that, although a substantial portion of the following detailed description may be provided in the context of oilfield hydraulic fracturing operations, other oilfield operations such as cementing, gravel packing, etc., or even non-oilfield well treatment operations, can utilize and benefit as well from the instant disclosure.

In some embodiments according to the present disclosure, a method comprises injecting above a fracturing pressure into a fracture in the formation a treatment fluid comprising a mixture of proppant particles and shapeshifting particles dispersed in a carrier fluid, changing a conformation of the shapeshifting particles in the fracture, and reducing the pressure to close the fracture onto the proppant particles. In some embodiments, the treatment fluid comprises a high solids content. In some embodiments, the treatment fluid comprises a multimodal particle size distribution.

In some embodiments, the shapeshifting particles have a first set of spatial dimensions corresponding to a first conformation, which may or may not be an equilibrium conformation, at a first set of conditions, and a second set of spatial dimensions corresponding to a second conformation, which likewise may or may not be an equilibrium conformation, at a second set of conditions, wherein the second set of spatial dimensions comprises at least one dimensional characteristic or aspect ratio that is substantially different than the corresponding dimensional characteristic or aspect ratio of the first conformation to displace proppant particles positioned adjacent shapeshifting particles in the fracture. “Equilibrium” here refers to a static conformation at thermal, pressure and chemical equilibrium with the surrounding environment, wherein any residual stresses in the shapeshifting particles are insufficient to induce a change in the shape or spatial dimensions.

In some embodiments, the displacement of the proppant particles forms spaced-apart clusters of the proppant, or interconnected, hydraulically conductive channels between the clusters or a combination of clusters and channels. In some embodiments, the method may further comprise changing an environment of the shapeshifting particles from the first set of conditions prior to distribution of the proppant into the fracture to the second set of conditions in the fracture prior to fracture closure. In some embodiments, the shapeshifting particles may be allowed to only partially reach the second equilibrium conformation, or may be allowed to fully reach the second equilibrium conformation, prior to the fracture closure. In some embodiments, the changing of the environment of the shapeshifting particles may comprise: increasing a temperature of the shapeshifting particles in the fracture; contacting the shapeshifting particles in the fracture with an acid, a base, an oxidizer, a reducing compound, an aqueous solvent, an oleaginous solvent, or a combination thereof; contacting the shapeshifting particles in the fracture with an acid or a base in an amount sufficient to change a pH in the fracture by +/−5 pH units; and the like, or any combination of these. In some embodiments, the clusters and the interconnected hydraulically conductive channels between the clusters are distributed to substantially retain fines in the fracture during flowback of fluid from the formation into the wellbore.

In some embodiments, the proppant particles may comprise at least one particle size distribution mode, the shapeshifting particles may comprise at least one particle size distribution mode, which may be the same or different with respect to the proppant particle size distribution mode(s), and the treatment fluid may comprise one or more additional particle size distribution modes.

In some embodiments, the method may further comprise: while maintaining a continuous rate of injection of the treatment fluid into the fracture at a continuous concentration of the proppant particles, successively alternating a concentration of the shapeshifting particles in the injected treatment fluid between a plurality of relatively shapeshifting particle-rich modes and a plurality of shapeshifting particle-lean modes; and after injecting the shapeshifting particles into the formation, transitioning the shapeshifting particles from a first conformation present prior to injection into the fracture to a second conformation to form spaced-apart clusters of the plurality of particulates in the fracture.

In some embodiments, the treatment fluid may comprise a high solids content fluid comprising proppant particles and shapeshifting particles in a dispersion in a carrier fluid at a first set of conditions wherein the shapeshifting particles have a first set of spatial dimensions corresponding to a first conformation, which may or may not be an equilibrium conformation, at the first set of conditions, and a second set of spatial dimensions corresponding to a second conformation, which likewise may or may not be an equilibrium conformation, at a second set of conditions, wherein the second set of spatial dimensions comprises at least one dimensional characteristic or aspect ratio that is substantially different than the corresponding dimensional characteristic or aspect ratio of the first conformation.

In some embodiments, the shapeshifting particles comprise fibers, ribbons, flakes, films, sheets, platelets, or a combination thereof. In some embodiments, the shapeshifting particles may have an aspect ratio of greater than or equal to about 6, or the proppant particles may have an aspect ratio less than 2, or both.

In some embodiments, the shapeshifting particles comprise fibers having a sheath comprising a first component disposed around a core comprising a second component different from the first component. In some embodiments, the first component and the second component have different crystallinities, different coefficients of thermal expansion, or a combination thereof. In some embodiments, the shapeshifting particles comprise a shrinkable film. In some embodiments, the shrinkable film comprises a polyurethane, two or more dissimilar layers, or a combination thereof. In some embodiments, the shapeshifting particles are fibers selected from the group consisting of eccentric or concentric side-by-side multicomponent fibers, islands-in-the-sea multi-component fibers, segmented-pie cross-section type multi-component fibers, radial type multi-component fibers, core-sheath multicomponent fibers, and a combination thereof.

In some embodiments, a system to treat a subterranean formation comprises: a subterranean formation penetrated by a wellbore; a treatment fluid supply unit to supply the treatment fluid comprising proppant particles and shapeshifting particles; a pump system to continuously deliver the treatment fluid from the supply unit through the wellbore to the formation at a pressure above fracturing pressure to inject the treatment fluid into a fracture in the formation; and a triggering system to change the first set of conditions from the treatment fluid supply unit to the second set of conditions in the fracture. In some embodiments, the system may further comprise a shut-in system to maintain and then reduce pressure in the fracture.

In some embodiments according to the disclosure herein, an in situ method and system are provided for increasing fracture conductivity. By “in situ” is meant that channels of relatively high hydraulic conductivity are formed in a fracture after it has been filled with a generally continuous proppant particle concentration. As used herein, a “hydraulically conductive fracture” is one which has a high conductivity relative to the adjacent formation matrix, whereas the term “conductive channel” refers to both open channels as well as channels filled with a matrix having interstitial spaces for permeation of fluids through the channel, such that the channel has a relatively higher conductivity than adjacent non-channel areas.

The term “continuous” in reference to concentration or other parameter as a function of another variable such as time, for example, means that the concentration or other parameter is an uninterrupted or unbroken function, which may include relatively smooth increases and/or decreases with time, e.g., a smooth rate or concentration of proppant particle introduction into a fracture such that the distribution of the proppant particles is free of repeated discontinuities and/or heterogeneities over the extent of proppant particle filling. In some embodiments, a relatively small step change in a function is considered to be continuous where the change is within +/−10% of the initial function value, or within +/−5% of the initial function value, or within +/−2% of the initial function value, or within +/−1% of the initial function value, or the like over a period of time of 1 minute, 10 seconds, 1 second, or 1 millisecond. The term “repeated” herein refers to an event which occurs more than once in a stage.

Conversely, a parameter as a function of another variable such as time, for example, is “discontinuous” wherever it is not continuous, and in some embodiments, a repeated relatively large step function change is considered to be discontinuous, e.g., where the lower one of the parameter values before and after the step change is less than 80%, or less than 50%, or less than 20%, or less than 10%, or less than 5%, or less than 2% or less than 1%, of the higher one of the parameter values before and after the step change over a period of time of 1 minute, 10 seconds, 1 second, or 1 millisecond.

As used herein, a “shapeshifting particle” refers to a particle that can change its conformation under conditions of use from a first set of spatial dimensions to a second set of spatial dimensions, wherein the second set of spatial dimensions comprises at least one dimensional characteristic or aspect ratio that is substantially different than the first set of spatial dimensions. As used herein, “substantially different” means that a larger one of the dimensional characteristics or aspect ratio is at least 20% larger than a corresponding smaller one of the dimensional characteristics or aspect ratio, however, in some embodiments, the larger one may be at least 50%, or at least 60%, or at least 70%, or at least 75%, or at least 80%, or at least 90%, or at least 100%, or at least 150%, or at least 200%, or at least 250%, relative to the smaller characteristic dimension or aspect ratio. Shapeshifting thus contemplates stretching, shrinking, bending, straightening, folding, unfolding, curling, uncurling, twisting, untwisting, corkscrewing, inflating, deflating, and so forth, or any combination of these. On the other hand, shapeshifting does not encompass normal or typical thermal expansion or contraction of a material due to ambient temperature, e.g., less than 5 or 10% of the original dimension.

In some embodiments, the conformational changes of the shapeshifting particles may be sufficient to displace particles, e.g., proppant particles or other shapeshifting particles or other particles, positioned adjacent to the shapeshifting particle undergoing shapeshifting. For example, a shapeshifting particle may be a relatively long fiber that bends and shrinks, or an extended network of intertwined fibers, or a branched fiber, so that when it changes from an extended conformation in a loosely packed or distributed bed of relatively smaller particles (e.g., sand or proppant), it tends to draw the smaller particles together within the bends or the spaces between the adjacent fibers or branches, and form voids or channels in the space previously occupied by the original conformation of the shapeshifting particle and/or by the displaced particles. As another example, the shapeshifting particle may expand or unwind to push the adjacent particles away from the shapeshifting particles, and the channels may optionally be formed from the shapeshifting particle having an open or porous structure, or by shrinking, degrading or removing the shapeshifting particle, or the like.

In some embodiments, the shapeshifting particles may have a first set of spatial dimensions corresponding to a first conformation at a first set of conditions and a second set of spatial dimensions corresponding to a second conformation at a second set of conditions, wherein the second set of spatial dimensions comprises at least one dimensional characteristic or aspect ratio that is substantially different than the corresponding dimensional characteristic or aspect ratio of the first conformation to displace proppant particles positioned adjacent shapeshifting particles in the fracture. In embodiments, the at least one dimensional characteristic or aspect ratio of the second conformation is less than the corresponding dimensional characteristic or aspect ratio of the first conformation.

The set of conditions may include one or more of temperature, pressure, pH, and/or the like, and refers to the immediate environment in which the particles are located. In embodiments, a set of conditions may include the presence or relative absence of a solvent, an acid, a base, an oxidizer, a reducing compound, and/or the like, which result in the particle changing from a first shape to a second shape. It is to be understood that in embodiments, changing a first set of conditions into the second set of conditions may not require any external action, but may simply be the result of temperature equilibration in which a fluid at surface temperature is disposed within a wellbore, formation or fracture having a higher temperature than is present at the surface. Upon disposition, the temperature of the fluid rises as the temperature of the fluid equilibrates with the temperature of the formation where the fluid is located. In other embodiments, changing a first set of conditions into the second set of conditions may require direct action to raise pH, supply one or more breakers or other chemical triggers or stimuli, and/or the like.

In embodiments, the treatment fluids may be used for providing some degree of sand control in a portion of the subterranean formation. In the sand control embodiments, the treatment fluid is introduced into the well bore that penetrates the subterranean formation such that the particulates form a gravel pack in or adjacent to a portion of the subterranean formation.

In embodiments, a high solid content fluid according to embodiments disclosed herein containing a multimodal sized particulates (Apollonianistic particle size distribution) comprising proppants and shapeshifting particles, which may further include a surfactant and/or a viscosifying agent such as diutan or guar may be placed in a fracture. With time the temperature of the fluid may change from a first set of conditions to a second set of conditions resulting in the shapeshifting particles decreasing in volume or otherwise changing in shape to create a more conductive pathway through the proppant pack. In embodiments, the change from the first set of conditions to the second set of conditions may be brought about by a change in pH, or by contact of another chemical or physical trigger. In embodiments, an acid such as encapsulated fumaric acid, or another such chemical trigger composition may also be used in the fluid such that the acid (or the chemical trigger material) is released with time or closure stress to bring about the change from a first set of conditions to a second set of conditions resulting in the shapeshifting particles decreasing in volume to create a more conductive pathway through the proppant pack. In embodiments, the trigger is supplied by the formation itself, and may include oleaginous fluids inherently present therein, ionic species inherently present therein, acidic or basic species inherently present therein, and/or the like.

In embodiments, the changed in shape of a shapeshifting particle results in a decrease in volume of the particle, or a decrease in the fit of a particle within a proppant pack such that the change in shape of a particle from a first shape to a second shape results in an increase in the porosity of a proppant pack, and/or results in a reduction of the packed volume fraction of the plurality of particles. In embodiments, the difference in shape includes occupying a volume which is less than an initial volume when the shapeshifting particles are placed under a second set of conditions. In embodiments, the difference in shape includes occupying a volume which is greater than an initial volume when the shapeshifting particles are placed under a second set of conditions, thereby disrupting the proppant pack.

In embodiments, the absolute value of the change in volume of the particle between the first or initial shape and the second or final shape is greater than or equal to about 5%, or greater than or equal to about 10%, or greater than or equal to about 15%, or greater than or equal to about 20%, or greater than or equal to about 50%, or greater than or equal to about 70%, or greater than or equal to about 80%, relative to the initial or first volume.

Changes in shape may include elongation of a particle, dissolution of at least a portion of a particle, shrinkage of a particle, and/or the like. Changes in conditions include differences in temperature, and/or applied pressure, and/or with sorption of fluids such as oil and water and/or reaction of one or more materials of the particle with a chemical trigger (e.g., an oxidizing agent, a reducing agent, a hydrolysis agent, and/or the like) placed in contact with the particle, and/or with changes in pH, salinity, and/or the like.

In embodiments, the shapeshifting particles may undergo a change in shape based at least in part on the pressure applied to the particles. Accordingly, in embodiments, the shapeshifting particles may be crushable such that upon application of an amount of force the particles experience a reduction in volume, thereby forming channels in a proppant pack.

In embodiments, the first set of conditions comprises a first temperature and the second set of conditions comprises a second temperature which is at least about 10° C. higher than the first temperature, or at least about 15° C. higher, or at least about 20° C. higher, or at least about 30° C. higher, or at least about 40° C. higher than the first temperature.

In embodiments, the first set of conditions comprises a first pH, the second set of conditions comprises a second pH, and a difference between the first pH and the second pH is at least about +/−5 pH units, or at least about +/−7 pH units. In embodiments, the first set of conditions comprises a first pH which is greater than or equal to about 7, and the second set of conditions comprises a second pH which is less than or equal to about 5, or less than or equal to about 3, or less than or equal to about 1. In embodiments, the first set of conditions comprises a first pH which is less than or equal to about 7, and the second set of conditions comprises a second pH which is greater than or equal to about 9, or greater than or equal to about 11, or greater than or equal to about 14.

In embodiments a method for treating a subterranean formation penetrated by a wellbore, comprises injecting a treatment fluid into a wellbore above a fracturing pressure to form a fracture in the formation, continuously distributing the treatment fluid into the formation; the treatment fluid comprising a plurality of particulates comprising proppant and a plurality of shapeshifting particles dispersed in a carrier fluid, the shapeshifting particles having a first shape occupying a first volume at a first set of conditions and a second shape occupying a second volume which is less than the first volume at a second set of conditions; the plurality of particles further comprising a plurality of particle size distribution modes having a packed volume fraction of 0.75 or higher at the first set of conditions; changing the first set of conditions into the second set of conditions within at least a portion of the fracture to form spaced-apart clusters of the plurality of particulates in the fracture; and reducing pressure in the fracture to prop the fracture open on the clusters and form interconnected, hydraulically conductive channels between the clusters. In embodiments, a treatment fluid has a continuous concentration of a first plurality of solid particulate, e.g., proppant, and a discontinuous concentration of shapeshifting particles that facilitates clustering conductivity of the first solid particulate in the fracture upon a change in shape of the shapeshifting particles, to prop open the fracture upon closure.

In embodiments, the treatment fluid is supplied to the wellbore at a constant rate. In embodiments, the concentration of one or more components of the treatment fluid may be varied or may be supplied at a discontinuous concentration. In embodiments, the concentration of the shapeshifting particles may be varied or may be supplied at a discontinuous concentration.

In embodiments, a method for treating a subterranean formation penetrated by a wellbore comprises injecting into a fracture in the formation at a continuous rate, at a continuous particulate concentration, under a first set of conditions, a treatment fluid comprising a first plurality of particulates comprising proppant and a plurality of particle size distribution modes having a packed volume fraction of 0.75 or higher under the first set of conditions; while maintaining the continuous rate of injection of the treatment fluid at the continuous particulate concentration of the first plurality of particulates, successively alternating a concentration mode of a plurality of shapeshifting particle in the treatment fluid between a plurality of relatively shapeshifting particle-rich modes and a plurality of shapeshifting particle-lean modes injected into the fracture; the shapeshifting particles having a first shape occupying a first volume at the first set of conditions and a second shape occupying a second volume which is less than the first volume at a second set of conditions; changing the first set of conditions into the second set of conditions within at least a portion of the fracture to form spaced-apart clusters of the plurality of particulates in the fracture; and reducing pressure in the fracture to prop the fracture open on the clusters and form interconnected, hydraulically conductive channels between the clusters.

In embodiments, the shapeshifting particle-lean concentration mode is free or essentially free of shapeshifting particles, or a difference between the concentrations of the shapeshifting particle-rich and shapeshifting particle-lean modes is at least 10, or at least 25, or at least 40, or at least 50, or at least 60, or at least 75, or at least 80, or at least 90, or at least 95, or at least 98, or at least 99, or at least 99.5 weight percent of the shapeshifting particle concentration of the shapeshifting particle-rich mode. A shapeshifting particle-lean mode is essentially free of the shapeshifting particles if the concentration of the shapeshifting particles is insufficient to form channels or improve the conductivity of a proppant pack upon changing the conditions from a first set of conditions to a second set of conditions relative to the shapeshifting particles.

In embodiments, the conductive channels extend in fluid communication from adjacent a face of in the formation away from the wellbore to or to near the wellbore, e.g., to facilitate the passage of fluid between the wellbore and the formation, such as in the production of reservoir fluids and/or the injection of fluids into the formation matrix. As used herein, “near the wellbore” refers to conductive channels coextensive along a majority of a length of the fracture terminating at a permeable matrix between the conductive channels and the wellbore, e.g., where the region of the fracture adjacent the wellbore is filled with a permeable solids pack as in a high conductive proppant tail-in stage, gravel packing, or the like.

In embodiments, the injected treatment fluid stage comprises a viscosified carrier fluid, and the method may further comprise reducing the viscosity of the carrier fluid in the fracture to induce or facilitate a change in the conditions from a first set of conditions to a second set of conditions prior to closure of the fracture, and thereafter allowing the fracture to close.

The term “treatment,” or “treating,” refers to any subterranean operation that uses a fluid in conjunction with a desired function and/or for a desired purpose. The term “treatment” or “treating” does not imply any particular action by the fluid.

The term “fracturing” refers to the process and methods of breaking down a geological formation and creating a fracture, i.e. the rock formation around a well bore, by pumping fluid at very high pressures (pressure above the determined closure pressure of the formation), in order to increase production rates from a hydrocarbon reservoir. Fracture creation refers to both initiation of a new fracture or branch thereof as well as propagation or growth of a new or existing fracture.

As used herein unless otherwise specified, as described in further detail herein, particle size and particle size distribution (PSD) mode refer to the volume average size. The size used herein may be any value understood in the art, including for example and without limitation a diameter of roughly spherical particulates. In embodiments, the size may be a characteristic dimension, which may be a dimension considered most descriptive of the particles for specifying a size distribution range.

The term “proppant” includes proppant or gravel used to hold fractures open and also includes gravel or proppant used in a gravel packing and/or a frac-pack operation.

“Carrier,” “carrier fluid,” “fluid phase” or “liquid phase” each refer to the fluid or liquid that is present as a continuous phase in the fluid. Reference to an “aqueous phase” refers to a carrier phase comprised predominantly of water, which may be a continuous or dispersed phase. As used herein the terms “liquid” or “liquid phase” encompasses both liquids per-se and supercritical fluids, including any solutes dissolved therein.

The terms “particulate,” “particle” and “particle size” used herein refer to discrete quantities of solids, gels, semi-solids, liquids, gases and/or foams unless otherwise specified.

As used herein, a blend of particles and a fluid may be generally referred to as a slurry, an emulsion, or the like. For purposes herein “slurry” refers to a mixture of solid particles dispersed in a fluid carrier. An “emulsion” refers to a form of slurry in which the particles are of a size such that the particles do not exhibit a static internal structure, but are assumed to be statistically distributed. In some embodiments, an emulsion is a mixture of two or more liquids that are normally immiscible (nonmixable or unblendable). For purposes herein, an emulsion comprises at least two phases of matter, which may be a first liquid phase dispersed in a continuous (second) liquid phase, and/or a first liquid phase and one or more solid phases dispersed in a continuous (second) liquid phase. Emulsions may be oil-in-water, water-in-oil, or any combination thereof, e.g., a double emulsion such as a “water-in-oil-in-water” emulsion or an “oil-in-water-in-oil” emulsion.

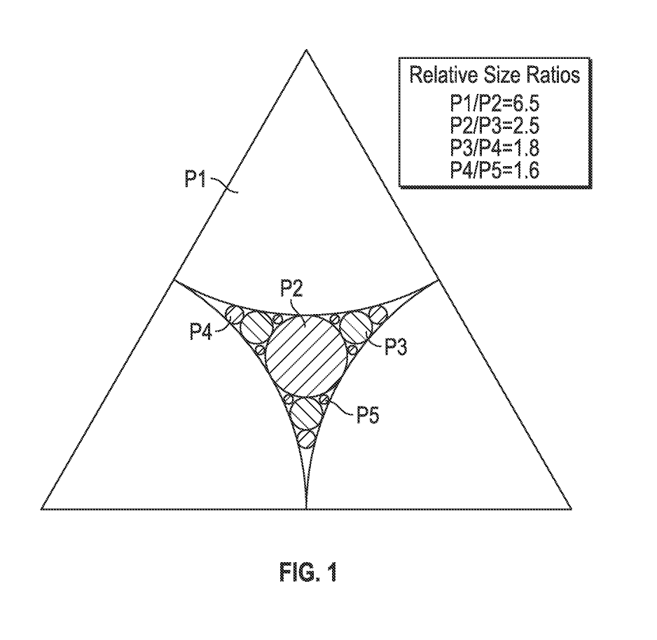

Apollonian packing of particles refers to the presence of successively smaller particles to fit in the interstices of the larger particles, which are assumed spherical for purposes herein unless otherwise specified. For example, randomly packed monodisperse spheres, regardless of size, may have a packed volume fraction (PVF) on the order of 0.64. By providing smaller spheres that can occupy the interstices between the larger spheres, the overall PVF can be increased. FIG. 1 illustrates an approximate pentamodal Apollonian packing model obtained using the Descartes circle theorem. For four mutually tangent circles with curvatures Pₙ, Pₙ₊₁, Pₙ₊₂, Pₙ₊₃, the following equation (1) is applicable:

$$\frac{1}{{P}_{n}^{2}} + \frac{1}{{P}_{n + 1}^{2}} + \frac{1}{{P}_{n + 2}^{2}} + \frac{1}{{P}_{n + 1}^{1}} = \frac{1}{2} {( \frac{1}{{P}_{n}} + \frac{1}{{P}_{n + 1}} + \frac{1}{{P}_{n + 2}} + \frac{1}{{P}_{n + 1}} )}^{2} \qquad ( 1 )$$

where Pₙ is the curvature of circle n, where curvature is taken as the reciprocal of the radius. For example, when three equally sized spheres (Size P1=1) are touching each other, the size (diameter) ratio of P1/P2 can be obtained using the above equation to be 6.464˜6.5. Similarly, other ratios for successively smaller particle sizes required can be estimated as P2/P3 being about 2.5 and P3/P4 being about 1.8, and when a fifth particle is used, P4/P5 is about 1.6.

As used herein, the terms “Apollonianistic,” “Apollonianistic packing,” “Apollonianistic rule,” “Apollonianistic particle size distribution,” “Apollonianistic PSD” and similar terms, refer to a multimodal volume-averaged particle size distribution with particle size distribution (PSD) modes that are not necessarily strictly Apollonian wherein either (1) a first PSD mode comprises particulates having a volume-average size (diameter) at least 1.5 times larger, or 3 times larger, or from 7 to 20 times larger than the volume-average size of at least a second PSD mode such that a packed volume fraction (PVF) of the particulates present in the mixture is equal to or exceeds 0.75 or (2) the particle mixture comprises at least three PSD modes, wherein a first amount of particulates have a first PSD mode, a second amount of particulates have a second PSD mode, and a third amount of particulates have a third PSD mode, wherein the first PSD mode is from 1.5 to 25 times, or from 2 to 10 times larger than the second PSD mode, and wherein the second PSD mode is at least 1.5 times larger than the third PSD mode. For purposes herein, the packed volume fraction or packing volume fraction (PVF) is the fraction of solid particulate content volume to the total volume occupied by the solid particulates. Accordingly, a plurality of particles having a PVF of 0.75 has 25% empty space within the total volume occupied by the plurality of particles in a pack.

Treatment fluids having an Apollonianistic particle size distribution are also referred to herein as high solid content fluids (HSCF). In some embodiments, HSCF may comprise or at least 5 volume percent solids (1.16 ppa sand (sp. Gr.=2.65), where ppa=pounds added per gallon of carrier fluid), at least 10 volume percent solids (2.46 ppa sand), or at least 15 volume percent solids (3.9 ppa sand), or at least 20 volume percent solids (5.53 ppa sand), or at least 25 volume percent solids (7.37 ppa sand), or at least 30 volume percent solids (9.48 ppa sand), or at least 35 volume percent solids (11.9 ppa sand), or at least 40 volume percent solids (14.7 ppa sand), or at least 45 volume percent solids (18.1 ppa sand), or at least 50 volume percent solids (22.1 ppa sand), or at least 55 volume percent solids (27 ppa sand), based on the total volume of the treatment fluid and the total volume of the solids including proppant and shapeshifting and any other solid particles, up to a maximum amount of added solids at which the HSCF remains flowable. In some other embodiments, HSCF may comprise at least 0.12 kg solids per liter of carrier fluid (1 ppa), or at least 0.24 kg/L solids (2 ppa), or at least 0.36 kg/L solids (3 ppa), or at least 0.48 kg/L solids (4 ppa), or at least 0.72 kg/L solids (6 ppa), or at least 0.96 kg/L solids (8 ppa), or at least 1.2 kg/L solids (10 ppa), or at least 1.44 kg/L solids (12 ppa), or at least 1.68 kg/L solids (14 ppa), or at least 1.92 kg/L solids (16 ppa), or at least 2.16 kg/L solids (18 ppa), or at least 2.4 kg/L solids (20 ppa), or at least 2.64 kg/L solids (22 ppa), or at least 2.88 kg/L solids (24 ppa), or at least 3.12 kg/L solids (26 ppa), up to a maximum amount of added solids at which the HSCF remains flowable.

In embodiments, the particulate material is a blend comprising proppant. Proppant selection involves many compromises imposed by economical and practical considerations. Criteria for selecting the proppant type, size, size distribution in multimodal proppant selection, and concentration is based on the needed dimensionless conductivity. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated (curable), or pre-cured resin coated. Proppants and gravels in the same or different wells or treatments can be the same material and/or the same size as one another and the term proppant is intended to include gravel in this disclosure. In embodiments, irregular shaped particles may be used. International application WO 2009/088317 discloses a method of fracturing with a slurry of proppant containing from 1 to 100 percent of stiff, low elasticity, low deformability elongated particles. US patent application 2007/768393 discloses proppant that is in the form of generally rigid, elastic plate-like particles having a maximum to minimum dimension ratio of more than about 5, the proppant being at least one of formed from a corrosion resistant material or having a corrosion resistant material formed thereon.

In general the proppant used in some embodiments will have an average particle size of from about 0.15 mm to about 4.76 mm (about 100 to about 4 U.S. mesh), from about 0.15 mm to about 3.36 mm (about 100 to about 6 U.S. mesh), or from about 0.15 mm to about 4.76 mm (about 100 to about 4 U.S. mesh), more particularly, but not limited to 0.25 to 0.42 mm (40/60 mesh), 0.42 to 0.84 mm (20/40 mesh), 0.84 to 1.19 mm (16/20 mesh), 0.84 to 1.68 mm (12/20 mesh) and 0.84 to 2.38 mm (8/20 mesh) sized materials. In some embodiments, the proppant will be present in the slurry in a concentration from about 0.12 to about 0.96 kg/L (1 to 8 ppa), or from about 0.12 to about 0.72 kg/L (1 to 6 ppa), or from about 0.12 to about 0.54 kg/L (1 to 4.5 ppa). Also, there are slurries in some embodiments where the proppant is at a concentration up to 1.92 kg/L (16 ppa). In some embodiments, the slurry is foamed and the proppant is at a concentration up to 2.4 kg/L (20 ppa).

In embodiments, the treatment fluid is a slurry comprising particulate materials with defined particles size distribution modes. Suitable examples include those disclosed in U.S. Pat. No. 7,784,541, herewith incorporated by reference in its entirety. In embodiments, the selection of the size for the first amount of particulates is dependent upon the characteristics of the propped fracture, for example the closure stress of the fracture, the desired conductivity, the size of fines or sand that may migrate from the formation, and other considerations understood in the art. In embodiments, the selection of the size for the particulates is dependent upon the desired fluid loss characteristics, the size of pores in the formation, and/or the commercially available sizes of particulates.

In embodiments, the selection of the size and amounts of the various particle size distribution modes of the particulates is dependent upon maximizing or optimizing a packed volume fraction (PVF) of the mixture of the particulates. The packed volume fraction or packing volume fraction (PVF) is the fraction of solid content volume to the total volume content occupied by the particulates. In embodiments, a second average particle size distribution mode of between about seven to ten times smaller than the first amount of particulates contributes to maximizing the PVF of the mixture, or a size between about three to twenty times smaller, or between about three to fifteen times smaller, or between about three to ten times smaller will provide a sufficient PVF for most slurry. Further, the selection of the size (the average particle size distribution mode) of the second amount of particulates is dependent upon the composition and commercial availability of particulates of the type comprising the second amount of particulates. In embodiments, the particulates combine to have a PVF greater than or equal to about 0.75, or greater than or equal to about 0.80, or greater than or equal to about 0.85, or greater than or equal to about 0.90. In embodiments the particulates may have a PVF of greater than or equal to about 0.95. The optimization of the particle size distribution (Apollonianistic distribution) in some embodiments, such as, for example, fluids having a solid content with a PVF greater than or equal to 0.75, and dispersion of particles with high surface area, in some embodiments may allow high solid content fluids, such as, for example, slurries having a solids volume fraction (SVF) greater than or equal to about 50%, or greater than or equal to 60%, or greater than or equal to 70%, or greater than or equal to 80%, or greater than or equal to 90%, and less than or equal to an amount at which the slurry remains flowable or pumpable, such as for example less than or equal to about 99%, or less than or equal to 95%, or less than or equal to 90%, or less than or equal to 80%, or less than or equal to 70%.

The treatment fluid may further include a third amount of particulates having a third average particle size distribution mode that is smaller than the second average particle size. In embodiments, the slurry may have a fourth, a fifth or a sixth amount of particles, each having an average particle size distribution mode which is smaller in size than the next larger particle size distribution mode as dictated by Apollonianistic packing. In embodiments, particles having the same composition can be used for the third, fourth, fifth or sixth average particle size. In embodiments, different particle compositions can be used for the same third average particle size: e.g. in the third average particle size, half of the amount is a certain type of proppant and the other half is another type of proppant. For the purposes of enhancing the PVF of the slurry, more than three or four particles sizes may not typically be required. However, additional particles may be added for other reasons, including the shapeshifting particles according to embodiments disclosed herein, and/or to incorporate various chemical compositions of the additional particles, the ease of manufacturing certain materials into the same particles versus into separate particles, the commercial availability of particles having certain properties, and other reasons understood in the art.

In other embodiments, the shapeshifting particles have one or more particle size distribution modes which complete or further encompass the Apollonianistic packing under the first set of conditions. In embodiments, the shapeshifting particles have one or more particle size distribution modes which complete or further encompass the Apollonianistic packing under the first set of conditions, but which are not consistent with Apollonianistic packing under the second set of conditions.

In embodiments, the treatment fluid may comprise fumed silica. Fumed silica also known as pyrogenic silica consists of microscopic droplets of amorphous silica fused into branched, chainlike, three-dimensional secondary particles which then agglomerate into tertiary particles. The resulting powder has an extremely low bulk density and high surface area. The fumed silica is present in the treatment fluid in some embodiments at a concentration effective to reduce the settling rate of the particulate material in the treatment fluid. The concentration in some embodiments is less than about 2% by weight of the treatment fluid. In further embodiments, the concentration is less than about 1% by weight of the treatment fluid. In further embodiments, the concentration is less than about 0.6% by weight of the treatment fluid. In further embodiments, the concentration is in the range of about 0.001% to about 0.5% by weight of the treatment fluid. In further embodiments, the concentration is in the range of about 0.1% to about 0.5% by weight of the treatment fluid. Fumed silica particles in some embodiments are compatible with other additives that may be present in the treatment fluid, e.g., leak-off control additives (latex, nanoparticles, viscosifier . . . ) and antifoam, dispersant, surfactant.

In embodiments, the treatment fluid may further comprise a degradable solid or particulate material, which may be included and/or which may comprise at least a portion of the shapeshifting particles. In embodiments, the degradable material includes at least one of a lactide, a glycolide, an aliphatic polyester, a poly(lactide), a poly(glycolide), a poly(epsilon-caprolactone), a poly(orthoester), a poly(hydroxybutyrate), an aliphatic polycarbonate, a poly(phosphazene), and a poly(anhydride). In embodiments, the degradable material includes at least one of a poly(saccharide), dextran, cellulose, chitin, chitosan, a protein, a poly(amino acid), a poly(ethylene oxide), and a copolymer including poly(lactic acid) and poly(glycolic acid), and/or a copolymer including a first moiety which includes at least one functional group from a hydroxyl group, a carboxylic acid group, and a hydrocarboxylic acid group, the copolymer further including a second moiety comprising at least one of glycolic acid and lactic acid, and/or the degradable material is selected from the group consisting of polylactic acid (PLA), polyglycolic acid (PGA), polyethylene terephthalate (PET), polyester, polyamide, polycaprolactam, polycaprolactone, poly(butylenesuccinate), polydioxanone, glass, ceramics, carbon (including carbon-based compounds), elements in metallic form, metal alloys, wool, basalt, acrylic, polyethylene, polypropylene, novoloid resin, polyphenylene sulfide, polyvinyl chloride, polyvinylidene chloride, polyurethane, polyvinyl alcohol, polybenzimidazole, polyhydroquinone-diimidazopyridine, poly(p-phenylene-2,6-benzobisoxazole), rayon, cotton, and/or other natural fibers, rubber, sticky fiber, acrylic fiber, mica, or a combination thereof.

In embodiments, the degradable material is selected from substituted and unsubstituted lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, and mixtures of such materials. Examples include polyglycolic acid or PGA, and polylactic acid or PLA. These materials function as solid-acid precursors, and upon dissolution in the fracture, can form acid species which can have secondary functions in the fracture as for example clean-up of the unwanted particulate material or treatment fluid additives.

In embodiments, the treatment fluid can be made to be partially degradable when particles other than proppant are degradable i.e. they could disappear after a certain amount of time (following different processes: thermal degradation, thermal decomposition, dissolution hydrolysis, etc. when subjected to the second set of conditions). Degradation of particles leads to increase the permeability of the proppant pack. Degradation should take place after placement. Several kind of degradable particles can be used, including a mineral (e.g., a salt) and/or an organic compound (e.g., PLA, PGA, wax, and the like), or any combination thereof. In embodiments, the shapeshifting particle may comprise one or more layers or components comprising a degradable material and a portion which is non-degradable, such that the change in shape includes the dissolution or otherwise removal of the degradable material from the non-degradable material present in the particle.

In embodiments, the treatment fluid can comprise fiber. The fiber may be a shapeshifting particle or may not be shapeshifting (i.e., may occupy the same volume under the first set of conditions as it does under the second set of conditions) as defined relative to the shapeshifting particles. In embodiments, the fiber, whether shapeshifting or not, may provide reinforcement and consolidation of the proppant. Examples include glass, ceramics, carbon and carbon-based compounds, metals and metallic alloys, and the like, and combinations thereof. When such fibers are packed in the proppant, they tend to strengthen the proppant pillars. In embodiments, the fiber, whether shapeshifting or not, may be used to inhibit settling of the proppant in the treatment fluid. Examples include polylactic acid, polyglycolic acid, polyethyleneterephthalate (PET), polyol, and the like, and combinations thereof. Such fibers function to inhibit settling or dispersion of the proppant in the treatment fluid and may further serve as a primary removable fill material in the spaces between the pillars. Yet other applications include a mixture of the various types of fibers, the first fiber type providing reinforcement and consolidation of the proppant and the second fiber type inhibiting settling of the proppant in the treatment fluid.

Fibers suitable for use herein may be hydrophilic, hydrophobic, or any combination thereof along the fiber. Hydrophilic fibers may be preferred in embodiments, hydrophobic fibers may be preferred in other embodiments, and a combination of hydrophilic and hydrophobic fibers may be preferred in still other embodiments. For purposes herein, a fiber is considered be hydrophilic if readily wet by water. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. In embodiments, suitable fibers include polyester fibers coated to be highly hydrophilic, such as, but not limited to, DACRON® polyethylene terephthalate (PET) Fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like.

In embodiments, elongated shapeshifting particles (for example, fibers) and fibers known to be used in oilfield treatments, which include those, for example, used to transport proppant may be used. In embodiments, a concentration of the shapeshifting particles is sufficient to consolidate the particles present in the treatment fluid.

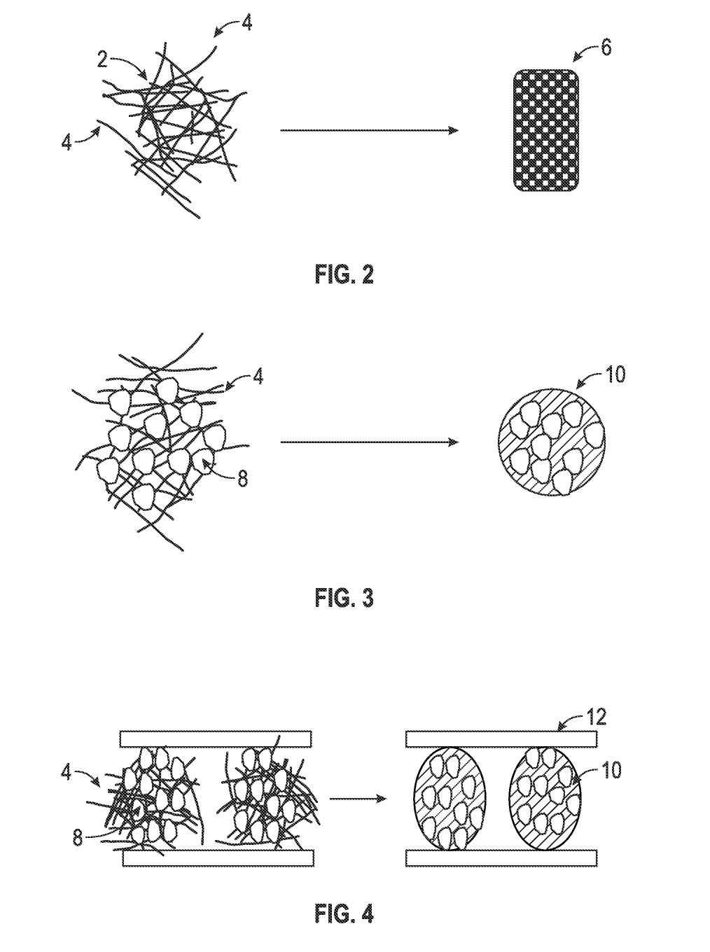

For purposes herein an elongated particle is defined as having a length to width ratio (an aspect ratio) of greater than or equal to about 20. In embodiments, shapeshifting particles which are fibers undergo physical changes, for example from long extended shapes to contracted structures, at certain temperatures, and/or under other conditions. FIG. 2 shows schematically a change in the initial structure of a loose aggregation or collection 2 of individual fibers 4 in their initial shapes into a tighter ball-like subsequent structure 6 made up of fibers in their subsequent shapes. It is known that many plastic or thermoplastic materials undergo such transformations when heated. For example, in addition to fibers, elongated shapeshifting particles include films (sheets), platelets (flakes), ribbons and other shapes formed from suitable materials may crumple up into contracted shapes.

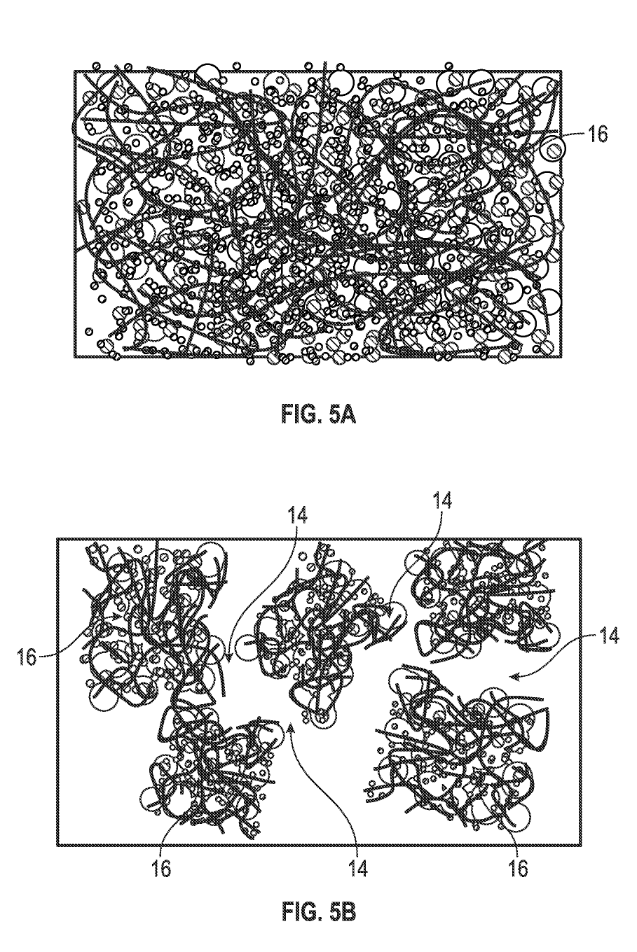

In embodiments the use of shapeshifting materials may be used to create heterogeneous proppant placement during hydraulic fracturing treatments by creating channel like structures in the proppant pack. In embodiments, the shapeshifting particles, such as fibers, are mixed with proppant and other particulates on the surface and pumped into a fracture as it is forming. In embodiments, as shown in FIG. 3, under reservoir conditions such materials may undergo physical changes, for example to create a more compact structure 10 of fibers 4 with proppants 8, resulting in clusters or pillar like structures between the fracture faces 12 as shown in FIG. 4. As shown in FIGS. 5A and 5B, in embodiments, the more compact structures or bundles form “islands” that keep the fracture open along its length but provide a plurality of channels 14, through the proppant pack 16, as shown in FIG. 5B, for the formation fluids to circulate; in contrast to a uniform proppant pack 16 shown in FIG. 5A. This arrangement may further retain free particles present in the formation during production, thus minimizing free particles flowing from the formation or wellbore to the surface during flowback or production.

In embodiments, the formation of more compact structures may further function to keep the fine particles present in the treatment fluid inside the pillar, which may, in addition to reinforcing the pillar, reduce or eliminate the flowback of particles during production.

High solid content fluids contain a relatively large number of particles of different sizes. Flowback of these free particles present in the wellbore during production can be problematic, resulting in conductivity loss, plugging, settling in surface lines, accumulation in surface facilities, and the like. Addition of shapeshifting particles to HSCF treatment fluids according to embodiments disclosed herein which further consolidate after triggering may thus be utilized to reduce or eliminate particle flowback during production or other operations.

In embodiments, the clusters and the interconnected hydraulically conductive channels between the clusters are dimensioned and arranged to retain a larger portion of the plurality of particles originally present in the treatment fluid during flowback of hydrocarbons from the formation into the wellbore, relative to an essentially similar wellbore treated essentially the same way but in the absence of the shapeshifting particles.

In embodiments, using shapeshifting particles is the sole method of creating proppant heterogeneity in fractures, e.g., the shapeshifting particles may be employed in treatment fluids with a generally continuous proppant loading pump schedule (including gradual increases or decreases in proppant loading), so that the proppant is more or less homogeneously distributed into the fracture and the channels and clusters are formed in situ within the fracture by conformational changes of the shapeshifting particles that occur after entry into the fracture. In embodiments, the ratio of shapeshifting particles to proppant may be constant or may vary as the proppant concentration varies from stage to stage. In embodiments, shapeshifting particles may be included in all stages or only in some stages of well treatment. The ratio of proppant to shapeshifting particles may vary, in part depending upon whether dense or fluid-permeable pillars are desired. In embodiments, the concentration of shapeshifting particles in the treatment fluid may be in the range of from about 0.012 to 3.6 kg/L (0.1 to 30 ppa), or about 0.12 to 2.4 kg/L (1 to 20 ppa), or about 0.24 to 1.92 kg/L (2 to 16 ppa).

In embodiments, the weight ratio of proppant and other non-shapeshifting particulates to shapeshifting particulates is from about 1:100 to about 100:1, or about 2:1 to about 10:1 based on the total mass of proppant and other non-shapeshifting particulate to the total mass of the shapeshifting particulate present. In some embodiments, a greater ratio of proppant to shapeshifting particulate may lead to a denser pillar and/or pillar field and less hydraulic conductivity. In some embodiments, increasing the concentration of the shapeshifting particulates relative to the proppant may result in a greater probability of creating a proppant pack consistent with FIG. 5B, which comprises a plurality of channels 14 in proppant pack 16; while in some embodiments decreasing the proportion of shapeshifting particulates relative to the proppant concentration may result in a greater probability of creating a wider and/or more homogeneous proppant pack 16 consistent with FIG. 5A.

In embodiments the shapeshifting particles may be used in conjunction with other methods of creating proppant heterogeneity in fractures. Other suitable methods include (a) sequentially injecting into the wellbore alternating stages of fracturing fluids having a contrast in their ability to transport propping agents to improve proppant placement, or having a contrast in the amount of transported propping agents; (b) pumping alternating fluid systems during the proppant stages applied to fracturing treatments using long pad stages and slurry stages at very low proppant concentrations; this is a form of what is commonly known as “waterfracs”, also known in the industry as “slickwater” treatments or “hybrid waterfrac treatments”; (c) pumping a first stage that involves injection into a borehole of fracturing fluid containing thickeners to create a fracture in the formation; and a second stage that involves periodic introduction of proppant into the injected fracturing fluid to supply the proppant into a created fracture, to form proppant clusters within the fracture to prevent fracture closure and to form channels for flowing formation fluids between the clusters, in which the second stage or its sub-stages may involve additional introduction of either a reinforcing or consolidation material or both, thus increasing the strength of the proppant clusters formed in the fracture fluid; and (d) injecting a well treatment fluid containing proppant and proppant-spacing filler material (called a channelant) through a wellbore into the fracture, heterogeneously placing the proppant in the fracture in a plurality of proppant clusters or islands spaced apart by the channelant, and removing the channelant filler material to form open channels around the pillars for fluid flow from the formation through the fracture toward the wellbore. In various embodiments, shapeshifting particles may be included in the proppant stages of any of these techniques to facilitate consolidation of the solids and thus to increase the heterogeneity of the final proppant placement; this may provide additional channel creation and increase the porosity, and thus the conductivity, of the proppant pack. In method (d) above, the channelant itself may be an elongated particle such as a polyvinyl alcohol fiber or a polylactic acid fiber that can aid in proppant transport and placement, and is or is not shapeshifting depending upon its structure and composition, and is soluble in the formation fluid and/or in the fracturing fluid at formation temperature.

In embodiments, the shapeshifting particles may be fibers that can shrink under downhole conditions (i.e., a second set of conditions). This action allows the mixtures of proppants and fibers to self-organize to create pillar-type structures. The shapeshifting particles in some embodiments may also serve as consolidating materials for the pillars, allowing the use of crushable materials as propping agents, which may make the hydraulic fracturing treatments more economical and logistically feasible in certain embodiments.

For purposes herein, the three-dimensional structure of a shapeshifting particle when the shapeshifting particle is initially mixed with a fluid and proppant (and optionally other solids such as non-shapeshifting fibers used for proppant transport, Apollonianistic packing, and the like), pumped downhole, and deposited in a subterranean location in a wellbore or in a formation, as the “initial” or “first” shape under the first set of conditions, and the three-dimensional structure of the shapeshifting particle after reshaping of the shapeshifting particle under the second set of conditions as the “subsequent” or “second” shape. Likewise, the three-dimensional structure of an accumulation of shapeshifting particles, and proppant and/or other particulates mixed with the shapeshifting particles which accumulates when initially deposited in a subterranean location in a wellbore or in a formation under a first set of conditions (e.g., temperature, concentration, pH, and/or the like) is referred to herein as the “initial” or “first” structure, and the three-dimensional structure of the shapeshifting particles and proppant and/or other particulates mixed with the shapeshifting particles under the second set of conditions and subsequent reshaping of the shapeshifting particles is referred to herein as the “subsequent” or “second” structure.

Suitable shapeshifting particles include, for example PLA fibers, which are shrinkable in general, as well as fibers and other particles made from amorphous polymers known to be shrinkable. In embodiments, shapeshifting particles include multicomponent materials, for example multicomponent fibers, for example two-component fibers. The initial shapes of suitable shapeshifting particles include fibers, films, ribbons, platelets, flakes and other shapes having an aspect ratio of greater than about 20 (the aspect ratio of a flake, ribbon or film is the ratio of the average surface area to the average thickness). Suitable structures of multicomponent fibers include, for example, side-by-side, sheath-core, segmented pie, islands-in-the-sea, and combination of such configurations, and methods of forming such multicomponent fibers, are well known to those of ordinary skill in the art of making fibers. For example, such fibers and methods of making them are described in U.S. Pat. No. 7,851,391. The differences in the compositions of the different components, and their consequent differences in behavior when subjected to changes in conditions from a first set of conditions to a second set of conditions downhole are responsible for the changes in shape.

In embodiments, a suitable property of shapeshifting particles is shrinkage. In embodiments, the shapeshifting particles comprise polylactic acid or other polymers which are subject to substantial heat shrinkage at elevated temperatures. The amount of shrinkage may be affected by polymer composition, molecular weight, degree of branching or crosslinking, presence of additives including nucleating agents, the stress inducing techniques or triggers, and the like. Shrinkage is generally measured by immersing a polymer in boiling water or treating it with hot air. The desired degree of shapeshifting particle shrinkage relates to the intended application of the shapeshifting particle. In embodiments, the shapeshifting particles includes stable or low shrinkage particles, having a shrinkage of less than about 20%, or less than about 15%. In embodiments, the shapeshifting particles include high shrinkage particles, which exhibit a degree of shrinkage of greater than 20%, or greater than 50% or from about 20% to about 80%.

Processes directed to production of shrinkable particles include those disclosed in U.S. Pat. No. 7,846,517, which is herein incorporated by reference. Shapeshifting particles suitable for use herein include materials having a shrinkage of from about 20 to about 80 percent, or from about 40 to about 80 percent, while more or less shrinkage may be suitable depending on other requirements including the particle sized distribution mode required to produce a HSCF treatment fluid having Apollonianistic packing.

In embodiments, suitable shapeshifting particles include two-component fibers made of a core material and a sheath material that have different melting points. The core material (for example a thermoplastic resin, for example a polypropylene or a polyester) normally is used to ensure the integrity of the material during use; this core is not normally melted as the shapeshifting particle is reshaped, and may, for example, form a three-dimensional network in the newly shaped subsequent structure, giving the subsequent structure strength. The sheath material (for example a thermoplastic resin, for example a polyethylene) has a lower melting and bonding temperature and thus may be used to hold the subsequent structure together and in the new shape. The melting point of the sheath material may be about 80° C.; the melting point of the core material may commonly be up to about 160° C. Such materials may be manufactured with the sheath and core eccentric or concentric, and the fibers may be available in conventional form or available commercially already in a crimped (zigzag), wavy, or spiral form. Such fibers are available, for example, from ES FIBERVISIONS. U.S. Patent Application Publication No. 2010/0227166, which is incorporated by reference herein, describes the preparation and use of such shrinkable fibers composed of a first thermoplastic resin and optionally a second thermoplastic resin having a higher melting point than the first thermoplastic resin. Examples of suitable thermoplastic resins include ethylene copolymers such as ethylene-vinyl acetate copolymer, ethylene-methacrylic acid copolymer and ethylene-acrylate copolymer, elastomer resins such as poly-alpha-olefin and styrene-ethylene-butylene-styrene copolymer, low-density polyethylene, linear low-density polyethylene, high-density polyethylene, polypropylene, and propylene copolymers such as ethylene-propylene copolymer and ethylene-butene-propylene copolymer.

In embodiments, suitable shapeshifting particles include those described in JP08209444, which is hereby incorporated herein by reference. Another example is a staple fiber obtained by extruding a copolyester including (A) isophthalic acid and (B) 2,2-bis{4-(2-hydroxyethoxyl)phenyl}propane as copolymerizing components, as described in JP10204722, which is hereby incorporated herein by reference. This latter fiber undergoes less than or equal to 20 percent shrinkage in boiling water, and 12 to 40 percent shrinkage in 160° C. dry air after treating in boiling water.

In embodiments, suitable shapeshifting particles include polyester fibers having a diol component and a dicarboxylic acid component; for example the diol may be 1,1-cyclohexanedimethanol or its ester-forming derivative (or biphenyl-2,2′-dicarboxylic acid or its ester-forming derivative) in an amount of 2 to 20 mole percent based on the whole dicarboxylic acid component. Such fibers were disclosed by Kuraray in JP 9078345 and JP 8113825. Other suitable materials from Kuraray include the polyester fibers described in U.S. Pat. No. 5,567,796.

Nippon Ester Company Ltd. has described several fibers which may be suitable for use as shapeshifting particles in embodiments herein. A highly shrinkable conjugated fiber disclosed in Japanese Patent Application No. JP 2003-221737 is composed of a polyester, A, containing polyethylene terephthalate as a main component (prepared by copolymerizing an aromatic dicarboxylic acid having a metal sulfonate group in an amount of from 3 to 7 mole percent based on the whole acid component or an isophthalic acid in an amount of from 8 to 40 mole percent) and a polyester, B, that is ethylene terephthalate. The difference in melting point between polyester A and polyester B is at least 5° C. and the difference between the heat of melting of polyester A and polyester B is at least 20 J/g. The dry heat shrinkage at 170° C. is at least 15 percent. Another fiber described by Nippon Ester Company Ltd. in Japanese Patent No. JP 08035120 is a highly shrinkable polyester conjugated fiber obtained by conjugate spinning in a side-by-side fashion of polyethylene terephthalate and a polyethylene terephthalate copolymerized with 8 to 40 mole percent of isophthalic acid at a weight ratio of from 20:80 to 70:30. The product having a single fiber fineness of 1 to 20 denier has a hot water shrinkage at 90° C. of from 70 to 95 percent.

Kaneka Corporation has described several fibers suitable for use as shapeshifting particles in embodiments described herein in U.S. Patent Application Publication No. 2002/0122937 and U.S. Pat. No. 7,612,000. They include a hollow shrinkable copolymer fiber made of acrylonitrile and a halogen-containing vinyl monomer manufactured by wet spinning followed by steam treatment, drying, and heating. Some examples contain one or more of acrylic acid, methacrylic acid, vinyl chloride, vinylidene chloride, vinyl esters (for example vinyl acetate, vinyl pyrrolidone, vinyl pyridine and their alkyl-substituted derivatives), amides, and methacrylic acid amides. In these references, one of the monomers may be halogen-containing to provide fire-resistance to the fiber; in some embodiments of the present application, this may not be necessary. Other examples are modacrylic shrinkable fibers made from 50 to 99 parts by weight of a polymer (A) containing 40 to 80 weight percent acrylonitrile, 20 to 60 weight percent of a halogen-containing monomer, and 0 to 5 weight percent of a sulfonic acid-containing monomer, and 1 to 50 parts by weight of a polymer (B) containing 5 to 70 weight percent acrylonitrile, 20 to 94 weight percent of an acrylic ester, and 16 to 40 weight percent of a sulfonic acid-containing monomer containing a methallylsulfonic acid or methallylsulfonic acid metal salt, and optionally no halogen-containing monomer. Some examples of the fibers contain from 10 to 50 percent voids, and shrink at least 15 percent (and often over 30 percent) at from 100 to 150° C. in 20 minutes. They may be crimped before use.

KB Seiren Ltd. has described in U. S. Patent Application Publication No. 2010/0137527 a fiber that is suitable for shapeshifting particles. It is a highly shrinkable (for example in boiling water) fiber that is composed of a mixture of a nylon-MXD6 polymer (a crystalline polyamide obtained from a polymerization reaction of metaxylenediamine and adipic acid) and a nylon-6 polymer in a weight ratio of from 35:65 to 70:30. The fiber is made by melt spinning and drawing or draw-twisting. The fiber shrinks 43 to 53 percent in hot water at from 90 to 100° C. Inorganic particles, for example TiO₂, may be added to improve the spinning process.

Shimadzu Corporation described in U.S. Pat. No. 6,844,063 a core-sheath conjugated fiber (that is a fiber having two or more different polymers in a single filament), that is suitable as a shapeshifting particle, made from a sheath of (A) a low heat-shrinkability component that is a highly crystalline aliphatic polyester (having a melting point above 140° C.) and a core of (B) a high heat-shrinkability polymer containing at least 10 percent by weight of a low crystallinity aliphatic polyester having a melting point lower than that of component (A) by at least 20° C. The difference in shrinkability may be at least 3 percent, it may be 5 to 70 percent, or it may be about 10 to about 50 percent. In addition to the core-sheath structure, U.S. Pat. No. 6,844,063 also describes other suitable conjugated structures such as concentric core-sheath, eccentric (non-concentric) core-sheath, parallel, keyhole, hollow, double core, non-circular (for example trilobe cross-section), hollow parallel, three-layered parallel, multi-layered parallel, one polymer disposed in radial alignment, sea-islands (or islands-in-the-sea), and others.

Kanebo Ltd. described, in Japanese Patent No. JP7305225, highly shrinkable polyester staple polymers obtained by melt-spinning a polymer made from a polyethylene terephthalate and subjecting it to specified melt-spinning drawing and post-treating processes under specified conditions. Examples are polyethylene terephthalate core-sheath structures with in which the core and sheath have different crystallinities.

U.S. Pat. No. 6,844,062 describes spontaneously degradable fibers and goods made with fibers having a core-sheath structure including (A) a low heat-shrinkable fiber component comprising a high crystalline aliphatic polyester and (B) a high heat-shrinkable fiber component comprising an aliphatic polyester, for example a low crystalline or non-crystalline aliphatic polyester. Examples of polymer (A) include homopolymers such as polybutylene succinate (melting point about 116° C.), poly-L-lactic acid (m.p. 175° C.), poly-D-lactic acid (m.p. 175° C.), polyhydroxybutyrate (m. p. 180° C.) and polyglycolic acid (m.p. 230° C.), and copolymers or mixtures of these with small amounts of other components. Polymer (B) is a component having a low crystallinity and a high heat shrinkability. The component used for the copolymerization or mixing with the homopolymers with high melting point such as polybutylene succinate, polylactic acid, polyhydroxybutyrate and polyglycolic acid can be suitably selected from the raw materials for the preparation of the above-mentioned aliphatic polyesters.

Yet another suitable shapeshifting material was described in U.S. Pat. No. 5,635,298. It is a monofilament having a core-sheath structure including a core of a thermoplastic polyester or copolyester and a sheath of a thermoplastic polyester, in which the polyester or copolyester of the core has a melting point of 200 to 300° C., or 220 to 285° C., and includes at least 70 mole percent, based on the totality of all polyester structural units, of structural units derived from aromatic dicarboxylic acids and from aliphatic diols, and not more than 30 mole percent, based on the totality of all polyester structural units, of dicarboxylic acid units which differ from the aromatic dicarboxylic acid units which form the predominant portion of the dicarboxylic acid units, and diol units derived from aliphatic diols and which differ from the diol units which form the predominant portion of the diol units, and the sheath is made of a polyester mixture containing a thermoplastic polyester whose melting point is between 200 and 300° C., or between 220 and 285° C., and a thermoplastic, elastomeric copolyether-ester with or without customary nonpolymeric additives. The core-sheath monofilaments, if the core and sheath materials are separately melted and extruded, then cooled, then subjected to an afterdraw and subsequently heat-set, all under conditions as specified in the patent, may have a dry heat shrinkage at 180° C. of from 2 to 30 percent.

U.S. Pat. No. 5,688,594 describes a hybrid yarn, the fibers of which are suitable shapeshifting materials for embodiments described herein. The hybrid yarn contains at least two varieties of filaments: (A) has a dry heat shrinkage of less than 7.5%, and (B) has a dry heat shrinkage of above 10%. Appropriate heating forces the lower-shrinking filaments to undergo crimping or curling. (A) is, for example, aramid, polyester, polyacrylonitrile, polypropylene, polyetherketone, polyetheretherketone, polyoxymethylene, metal, glass, ceramic or carbon, and (B) is, for example, drawn polyester, polyamide, polyethylene terephthalate, or polyetherimide.

Examples of suitable thermoplastic resin combinations shapeshifting particles made from films are low-density polyethylene/polypropylene, linear low-density polyethylene/polypropylene, ethylene-vinyl acetate copolymer/polypropylene, ethylene-methacrylic acid copolymer/polypropylene, propylene copolymer/polypropylene, low-density polyethylene/propylene copolymer, ethylene-vinyl acetate copolymer/propylene copolymer, and ethylene-methacrylic acid copolymer/propylene copolymer.

U.S. Pat. No. 4,857,399 describes a four-layer shrink film, pieces of which are suitable shapeshifting materials for embodiments described herein. The film comprises an ethylene-propylene random copolymer first layer, a blend of anhydride-modified ethylene copolymer adhesive and ethylene vinyl acetate as an inner core second layer, a blend of partially hydrolyzed ethylene vinyl acetate copolymer and amide polymer as a third layer, and a blend of anhydride-modified ethylene copolymer adhesive and ethylene vinyl acetate as a fourth layer.

U.S. Patent Application No. 20070298273 discloses biaxially-oriented multilayer thermoplastic heat shrinkable films, small pieces of which are suitable shapeshifting materials for embodiments described herein. Such films are made in one embodiment from (a) two outer-film layers each comprising a polyolefin, and (b) a core layer comprising a blend of at least 50% by weight relative to the core layer of a first material comprising an ethylene unsaturated-ester copolymer and a second material selected from ionomers (ionic copolymers and terpolymers formed from an olefin and an ethylenically unsaturated monocarboxylic acid having the carboxylic acid moieties partially or completely neutralized by a metal ion), ethylene/acid copolymers and terpolymers and blends thereof.

In some embodiments, such films are made from (a) two outer-film layers each comprising a blend of a linear low-density polyethylene, a very low-density polyethylene or an ultra low-density polyethylene copolymer and a low-density polyethylene, and (b) a core layer comprising a blend of at least 50% by weight relative to the core layer of a first material selected from the group consisting of ethylene vinyl acetate copolymer, ethylene butyl acetate copolymer, ethylene methyl acetate copolymer, ethylene ethyl acetate copolymer, and blends thereof, and a second material selected from the group consisting of ionomers, ethylene/acid copolymers and terpolymers, and blends thereof, and at least 20% by weight relative to the core layer of a second material selected from the group consisting of ionomers, ethylene/acid copolymers and terpolymers, and blends thereof.

In some embodiments, such films are made from (a) a first and a second outer-film layer each comprising a blend of a linear low-density polyethylene, a very low-density polyethylene or an ultra low-density polyethylene copolymer and a low-density polyethylene; (b) a core layer disposed between the first and second outer-film layers and comprising a blend of at least 50% by weight relative to the core layer of a first material selected from the group consisting of ethylene vinyl acetate copolymer, ethylene butyl acetate copolymer, ethylene methyl acetate copolymer, ethylene ethyl acetate copolymer, and blends thereof, and a second material selected from the group consisting of ionomers, ethylene/acid copolymers and terpolymers, and blends thereof, at least 20% by weight relative to the core layer of a second material selected from the group consisting of ionomers, ethylene/acid copolymers and terpolymers, and blends thereof, and between 0.2 to 1.0% by weight of an amide slip agent; in which the core layer has a thickness of at least 50% of the total thickness of the film; and (c) a first intermediate layer positioned between the first outer-film layer and the core layer, and a second intermediate layer positioned between the second outer-film layer and the core layer; and where each of the intermediated layers comprises a polyolefin.

In some embodiments, suitable shapeshifting particles may be made from small pieces of films prepared as described in U.S. Pat. No. 8,021,760, e.g., multilayer heat shrinkable films made with homopolymers and copolymers of a variety of resins such as the following polymers, their copolymers, or blends: polyolefin, polyethylene, ethylene/alpha olefin copolymer, ethylene/vinyl acetate copolymer; ionomer resin; ethylene/acrylic or methacrylic acid copolymer; ethylene/acrylate or methacrylate copolymer; low density polyethylene, polypropylene, polystyrene, polycarbonate, polyamide (nylon), acrylic polymer, polyurethane, polyvinyl chloride, polyvinylidene chloride, polyester, ethylene/styrene copolymer, norbornene/ethylene copolymer, and ethylene/vinyl alcohol copolymer.

Note that not all elongated particles, such as fibers and films, made with the compositions described above, are shapeshifting. The shapeshifting capability may depend upon such factors as crystallinity, branching, and molecular weight, and, in the case of copolymers, the relative ratios of the monomers. Furthermore, elongated shapeshifting particles, for example shrinkable fibers, may include shapeshifting portions, for example strands, and non-shapeshifting portions. The non-shapeshifting portions may be inert or may be removable, for example by melting, dissolving, or degrading. Suitable elongated shapeshifting particles may be obtained commercially or may be synthesized by those skilled in the relevant art.

In general according to some embodiments, the lower limit for fiber diameter for typical shrinkable organic fibers is about 1.3 dtex (11 microns), which is based primarily on current manufacturing limitations. The upper limit is based on limitations of typical oilfield pumping equipment.

The elongated shapeshifting particles may reduce the bulk volume of the solids inside a hydraulic fracture, because, after they are placed but before they are reshaped, they are dispersed. Upon reshaping, the fibers may coil up and intertwine with one another to form a denser structure that occupies less space, may decrease to a size, or may change in shape in an amount sufficient to be removed from the proppant pack, and/or the like.

In embodiments, the treatment fluid comprises particulates comprising proppant and shapeshifting particles dispersed in a carrier fluid, the particulates comprising a plurality of particle size distribution modes. In embodiments, the treatment fluid may optionally further comprise additional additives, which may be present in the continuous carrier fluid phase and/or the particulates phase, including, but not limited to, surfactants, viscosifiers, acids, fluid loss control additives, gas, corrosion inhibitors, scale inhibitors, catalysts, clay control agents, biocides, friction reducers, combinations thereof and the like. In embodiments, it may be desired to foam the treatment fluid using a gas, such as air, nitrogen, and/or carbon dioxide.

The surfactant, when present, may be selected from the group consisting of cationic, anionic, zwitterionic, amphoteric, nonionic and combinations thereof. Some non-limiting examples are those cited in U.S. Pat. No. 6,435,277 and U.S. Pat. No. 6,703,352, each of which is incorporated herein by reference. In general, particularly suitable zwitterionic surfactants have the formula:

RCONH—(CH₂)ₐ(CH₂CH₂O)ₘ(CH₂)_{b}—N⁺—(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH². In some embodiments, a zwitterionic surfactants of the family of betaine is used.

Exemplary cationic surfactants include the amine salts and quaternary amine salts disclosed in U.S. Pat. Nos. 5,979,557, and 6,435,277 which are hereby incorporated by reference. Examples of suitable cationic surfactants include cationic surfactants having the structure:

R¹N⁺(R²)(R³)(R⁴)X⁻

in which R¹ has from about 14 to about 26 carbon atoms and may be branched or straight chained, aromatic, saturated or unsaturated, and may contain a carbonyl, an amide, a retroamide, an imide, a urea, or an amine; R², R³, and R⁴ are each independently hydrogen or a C₁ to about C₆ aliphatic group which may be the same or different, branched or straight chained, saturated or unsaturated and one or more than one of which may be substituted with a group that renders the R², R³, and R⁴ group more hydrophilic; the R², R³, and R⁴ groups may be incorporated into a heterocyclic 5- or 6-member ring structure which includes the nitrogen atom; the R², R³, and R⁴ groups may be the same or different; R¹, R², R³, and/or R⁴ may contain one or more ethylene oxide and/or propylene oxide units; and X− is an anion. Mixtures of such compounds are also suitable. As a further example, R¹ is from about 18 to about 22 carbon atoms and may contain a carbonyl, an amide, or an amine, and R², R³, and R⁴ are the same as one another and contain from 1 to about 3 carbon atoms.

Amphoteric surfactants are also suitable. Exemplary amphoteric surfactant systems include those described in U.S. Pat. No. 6,703,352, for example amine oxides. Other exemplary surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The surfactant may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R¹CON(R²)CH₂X

wherein R¹ is a hydrophobic chain having about 12 to about 24 carbon atoms, R² is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecenyl group, an octadecyl group, and a docosenoic group.

In embodiments, the treatment fluid is used as a fracturing fluid. The carrier fluid includes any base fracturing fluid understood in the art. Some non-limiting examples of carrier fluids include hydratable gels (e.g. guars, polysaccharides, xanthan, hydroxy-ethyl-cellulose, etc.), a cross-linked hydratable gel, a viscosified acid (e.g. gel-based), an emulsified acid (e.g. oil outer phase), an energized fluid (e.g. an N₂ or CO₂ based foam), and an oil-based fluid including a gelled, foamed, or otherwise viscosified oil, which may include the degradable oleaginous oil. Additionally, the carrier fluid may be a brine, and/or may include a brine. The carrier fluid may be water, DI water, tap water, seawater, produced water or any type of water available in the field.

The treatment fluid may further include a viscosifying agent. In embodiments, the viscosifying agent may be a crosslinked polymer, including a metal-crosslinked polymer. Suitable polymers for making the metal-crosslinked polymer viscosifiers include, for example, polysaccharides such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds, and synthetic polymers. Crosslinking agents based on boron, titanium, zirconium or aluminum complexes are typically used to increase the effective molecular weight of the polymer and make them better suited for use in high-temperature wells.

Other suitable classes of polymers effective as viscosifying agent include polyvinyl polymers, polymethacrylamides, cellulose ethers, lignosulfonates, and ammonium, alkali metal, and alkaline earth salts thereof. More specific examples of other typical water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyalkyleneoxides, other galactomannans, heteropolysaccharides obtained by the fermentation of starch-derived sugar and ammonium and alkali metal salts thereof.

Cellulose derivatives are used to a smaller extent, such as hydroxyethylcellulose (HEC) or hydroxypropylcellulose (HPC), carboxymethylhydroxyethylcellulose (CMHEC) and carboxymethycellulose (CMC), with or without crosslinkers. Xanthan, diutan, and scleroglucan, three biopolymers, have been shown to have excellent particulate-suspension ability even though they are more expensive than guar derivatives and therefore have been used less frequently, unless they can be used at lower concentrations.

In embodiments, the viscosifying agent is made from a crosslinkable, hydratable polymer and a delayed crosslinking agent, wherein the crosslinking agent comprises a complex comprising a metal and a first ligand selected from the group consisting of amino acids, phosphono acids, and salts or derivatives thereof. Also the crosslinked polymer can be made from a polymer comprising pendant ionic moieties, a surfactant comprising oppositely charged moieties, a clay stabilizer, a borate source, and a metal crosslinker. Said embodiments are described in U.S. Patent Publication US2008-0280790 and U.S. Pat. No. 7,786,050, each of which is incorporated herein by reference.

The viscosifying agent may be present in a lower amount than conventionally is included for a fracture treatment. The loading of a viscosifier, for example described in pounds of gel per 1,000 gallons of carrier fluid, is selected according to the particulate size (due to settling rate effects) and loading that a storable composition must carry, according to the viscosity required to generate a desired fracture geometry, according to the pumping rate and casing or tubing configuration of the wellbore, according to the temperature of the formation of interest, and according to other factors understood in the art.

In embodiments, the low amount of a viscosifying agent includes a hydratable gelling agent in the carrier fluid at less than 2.4 g per liter of carrier fluid (20 pounds per 1,000 gallons of carrier fluid (ppt)) where the amount of particulates in the storable composition are greater than 1.92 kg/L (16 ppa). In certain further embodiments, the low amount of a viscosifier includes a hydratable gelling agent in the carrier fluid at less than 2.4 g/L (20 ppt) where the amount of particulates in the storable composition are greater than 2.76 kg/L (23 ppa). In certain embodiments, the low amount of a viscosifier includes the carrier fluid with no viscosifier included. In certain embodiments a low amount of a viscosifier includes values greater than the listed examples, because the circumstances of the storable composition conventionally utilize viscosifier amounts much greater than the examples. For example, in a high temperature application with a high proppant loading, the carrier fluid may conventionally indicate a viscosifier at 6 g/L (50 ppt) where the amount of particulates in the storable composition are greater than 1.92 g/L (16 ppa), wherein 4.8 g/L (40 ppt) of gelling agent, for example, may be a low amount of viscosifier. One of skill in the art can perform routine tests of storable composition based on certain particulate blends in light of the disclosures herein to determine acceptable viscosifier amounts for a particular embodiment.

In embodiments, the carrier fluid may include an acid. The fracture may be a traditional hydraulic bi-wing fracture, and/or may be an etched fracture and/or one designed to produce wormholes such as developed by an acid treatment. The carrier fluid may include hydrochloric acid, hydrofluoric acid, ammonium bifluoride, formic acid, acetic acid, lactic acid, glycolic acid, maleic acid, tartaric acid, sulfamic acid, malic acid, citric acid, methyl-sulfamic acid, chloro-acetic acid, an amino-poly-carboxylic acid, 3-hydroxypropionic acid, a poly-amino-poly-carboxylic acid, and/or a salt of any acid. In embodiments, the carrier fluid includes a poly-amino-poly-carboxylic acid, and is a trisodium hydroxyl-ethyl-ethylene-diamine triacetate, mono-ammonium salts of hydroxyl-ethyl-ethylene-diamine triacetate, and/or mono-sodium salts of hydroxyl-ethyl-ethylene-diamine tetra-acetate. The selection of any acid as a carrier fluid depends upon the purpose of the acid—for example formation etching, damage cleanup, removal of acid-reactive particles, and the like, and further upon compatibility with the formation, compatibility with fluids in the formation, and compatibility with other components of the fracturing slurry and with spacer fluids or other fluids that may be present in the wellbore. The selection of an acid for the carrier fluid is understood in the art based upon the characteristics of particular embodiments and the disclosures herein.

Accordingly, the present disclosure provides the following embodiments, among others:
1. A method for treating a subterranean formation penetrated by a wellbore, comprising: injecting above a fracturing pressure into a fracture in the formation a treatment fluid comprising a mixture of proppant particles and shapeshifting particles dispersed in a carrier fluid; changing a conformation of the shapeshifting particles in the fracture; and reducing the pressure to close the fracture onto the proppant particles.
2. The method of embodiment 1, wherein the treatment fluid comprises a high solids content.
3. The method of embodiment 1 or embodiment 2, wherein the shapeshifting particles have a first set of spatial dimensions corresponding to a first conformation at a first set of conditions and a second set of spatial dimensions corresponding to a second conformation at a second set of conditions, wherein the second set of spatial dimensions comprises at least one dimensional characteristic or aspect ratio that is substantially different than the corresponding dimensional characteristic or aspect ratio of the first conformation to displace proppant particles positioned adjacent shapeshifting particles in the fracture.
4. The method of embodiment 3, wherein the displacement of the proppant particles forms spaced-apart clusters of the proppant and interconnected, hydraulically conductive channels between the clusters.
5. The method of embodiment 3 or embodiment 4, further comprising changing an environment of the shapeshifting particles from the first set of conditions prior to distribution of the proppant into the fracture to the second set of conditions in the fracture prior to fracture closure.
6. The method of embodiment 5, further comprising allowing the shapeshifting particles to reach equilibrium at the second conformation prior to the fracture closure.
7. The method of embodiment 5 or embodiment 6, wherein the changing of the environment of the shapeshifting particles comprises increasing a temperature of the shapeshifting particles in the fracture.
8. The method of any one of embodiments 5 to 7, wherein the changing of the environment of the shapeshifting particles comprises contacting the shapeshifting particles in the fracture with an acid, a base, an oxidizer, a reducing compound, an aqueous solvent, an oleaginous solvent, or a combination thereof.
9. The method of any one of embodiments 5 to 8, wherein the changing of the environment of the shapeshifting particles comprises contacting the shapeshifting particles in the fracture with an acid or a base in an amount sufficient to change a pH in the fracture by +/−5 pH units.
10. The method of any one of embodiments 5 to 9, wherein the clusters and the interconnected hydraulically conductive channels between the clusters are distributed to substantially retain fines in the fracture during flowback of fluid from the formation into the wellbore.
11. The method of any one of embodiments 1 to 10, wherein the proppant particles comprise at least one particle size distribution mode, wherein the shapeshifting particles comprise at least one particle size distribution mode, and wherein the treatment fluid comprises one or more additional particle size distribution modes.
12. The method of any one of embodiments 1 to 11, further comprising: while maintaining a continuous rate of injection of the treatment fluid into the fracture at a continuous concentration of the proppant particles, successively alternating a concentration of the shapeshifting particles in the injected treatment fluid between a plurality of relatively shapeshifting particle-rich modes and a plurality of shapeshifting particle-lean modes; and after injecting the shapeshifting particles into the formation, transitioning the shapeshifting particles from a first conformation present prior to injection into the fracture to a second conformation to form spaced-apart clusters of the plurality of particulates in the fracture.
13. A treatment fluid, comprising: a high solids content fluid comprising proppant particles and shapeshifting particles in a dispersion in a carrier fluid at a first set of conditions; wherein the shapeshifting particles have a first set of spatial dimensions corresponding to a first conformation at the first set of conditions and a second set of spatial dimensions corresponding to a second conformation at a second set of conditions, wherein the second set of spatial dimensions comprises at least one dimensional characteristic or aspect ratio that is substantially different than the corresponding dimensional characteristic or aspect ratio of the first conformation.
14. The treatment fluid of embodiment 13, wherein the shapeshifting particles comprise fibers, ribbons, flakes, films, sheets, platelets, or a combination thereof, having an aspect ratio of greater than or equal to about 6.
15. The treatment fluid of embodiment 13 or embodiment 14, wherein the shapeshifting particles are shrinkable fibers.
16. The treatment fluid of any one of embodiments 13 to 15, wherein the shapeshifting particles are degradable.
17. The treatment fluid of any one of embodiments 13 to 16, wherein the shapeshifting particles comprise a polyester, a polyamide, a polyolefin, or a combination thereof.
18. The treatment fluid of any one of embodiments 13 to 17, wherein the shapeshifting particles comprise polylactic acid, polyglycolic acid, polyethylene terephthalate, poly(hydroxyalkanoate), nylon 6, nylon 6,6, nylon 6,12, polyethylene, polypropylene, polystyrene, poly(ethylene vinyl acetate), polyvinyl alcohol, 2-acrylamido-2-methylpropane sulfonic acid, or copolymers thereof.
19. The treatment fluid of any one of embodiments 13 to 18, wherein the shapeshifting particles comprise fibers having a sheath comprising a first component disposed around a core comprising a second component different from the first component.
20. The treatment fluid of embodiment 19, wherein the first component and the second component have different crystallinities, different coefficients of thermal expansion, or a combination thereof.
21. The treatment fluid of any one of embodiments 13 to 20, wherein the shapeshifting particles comprise a shrinkable film.
22. The treatment fluid of embodiment 21, wherein the shrinkable film comprises a polyurethane, two or more dissimilar layers, or a combination thereof.
23. The treatment fluid of any one of embodiments 13 to 22, wherein the shapeshifting particles are fibers selected from the group consisting of eccentric or concentric side-by-side multicomponent fibers, islands-in-the-sea multicomponent fibers, segmented-pie cross-section type multicomponent fibers, radial type multi-component fibers, core-sheath multicomponent fibers, and a combination thereof.
24. The treatment fluid of any one of embodiments 13 to 23, wherein the proppant particles have an aspect ratio less than 2.
25. A system to treat a subterranean formation, comprising: a subterranean formation penetrated by a wellbore; a treatment fluid supply unit to supply a treatment fluid according to any one of embodiments 13 to 24; a pump system to continuously deliver the treatment fluid from the supply unit through the wellbore to the formation at a pressure above fracturing pressure to inject the treatment fluid into a fracture in the formation; and a triggering system to change the first set of conditions from the treatment fluid supply unit to the second set of conditions in the fracture.
26. A system to treat a subterranean formation, comprising: a subterranean formation penetrated by a wellbore; a treatment fluid supply unit to supply a treatment fluid comprising proppant particles and shapeshifting particles dispersed in a carrier fluid at a first set of conditions, wherein the shapeshifting particles have a first set of spatial dimensions corresponding to a first conformation at the first set of conditions and a second set of spatial dimensions corresponding to a second conformation at a second set of conditions, wherein the second set of spatial dimensions comprises at least one dimensional characteristic or aspect ratio that is substantially different than the corresponding dimensional characteristic or aspect ratio of the first conformation; a pump system to continuously deliver the treatment fluid from the supply unit through the wellbore to the formation at a pressure above fracturing pressure to inject the treatment fluid into a fracture in the formation; and a triggering system to change the first set of conditions from the treatment fluid supply unit to the second set of conditions in the fracture.
27. The system of claim 26, further comprising a shut-in system to maintain and then reduce pressure in the fracture.

While the embodiments have been illustrated and described in detail in the drawings and foregoing description, the same is to be considered as illustrative and not restrictive in character, it being understood that only some embodiments have been shown and described and that all changes and modifications that come within the spirit of the embodiments are desired to be protected. It should be understood that while the use of words such as ideally, desirably, preferable, preferably, preferred, more preferred or exemplary utilized in the description above indicate that the feature so described may be more desirable or characteristic, nonetheless may not be necessary and embodiments lacking the same may be contemplated as within the scope of the disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

We claim:

1. A method for treating a subterranean formation penetrated by a wellbore, comprising:
injecting above a fracturing pressure into a fracture in the formation a treatment fluid comprising a mixture of proppant particles and shapeshifting particles dispersed in a carrier fluid;
changing a conformation of the shapeshifting particles in the fracture; and
reducing the pressure to close the fracture onto the proppant particles.

2. The method of claim 1, wherein the treatment fluid comprises a high solids content.

3. The method of claim 1, wherein the shapeshifting particles have a first set of spatial dimensions corresponding to a first conformation at a first set of conditions and a second set of spatial dimensions corresponding to a second conformation at a second set of conditions, wherein the second set of spatial dimensions comprises at least one dimensional characteristic or aspect ratio that is substantially different than the corresponding dimensional characteristic or aspect ratio of the first conformation to displace proppant particles positioned adjacent shapeshifting particles in the fracture.

4. The method of claim 3, wherein the displacement of the proppant particles forms spaced-apart clusters of the proppant and interconnected, hydraulically conductive channels between the clusters.

5. The method of claim 4, further comprising changing an environment of the shapeshifting particles from the first set of conditions prior to distribution of the proppant into the fracture to the second set of conditions in the fracture prior to fracture closure.

6. The method of claim 5, further comprising allowing the shapeshifting particles to reach equilibrium at the second conformation prior to the fracture closure.

7. The method of claim 5, wherein the changing of the environment of the shapeshifting particles comprises increasing a temperature of the shapeshifting particles in the fracture.

8. The method of claim 5, wherein the changing of the environment of the shapeshifting particles comprises contacting the shapeshifting particles in the fracture with an acid, a base, an oxidizer, a reducing compound, an aqueous solvent, an oleaginous solvent, or a combination thereof.

9. The method of claim 5, wherein the changing of the environment of the shapeshifting particles comprises contacting the shapeshifting particles in the fracture with an acid or a base in an amount sufficient to change a pH in the fracture by +/−5 pH units.

10. The method of claim 5, wherein the clusters and the interconnected hydraulically conductive channels between the clusters are distributed to substantially retain fines in the fracture during flowback of fluid from the formation into the wellbore.

11. The method of claim 1, wherein the proppant particles comprise at least one particle size distribution mode, wherein the shapeshifting particles comprise at least one particle size distribution mode, and wherein the treatment fluid comprises one or more additional particle size distribution modes.

12. The method of claim 1, further comprising:
while maintaining a continuous rate of injection of the treatment fluid into the fracture at a continuous concentration of the proppant particles, successively alternating a concentration of the shapeshifting particles in the injected treatment fluid between a plurality of relatively shapeshifting particle-rich modes and a plurality of shapeshifting particle-lean modes; and
after injecting the shapeshifting particles into the formation, transitioning the shapeshifting particles from a first conformation present prior to injection into the fracture to a second conformation to form spaced-apart clusters of the plurality of particulates in the fracture.

13. A treatment fluid, comprising:
a high solids content fluid comprising proppant particles and shapeshifting particles in a dispersion in a carrier fluid at a first set of conditions;
wherein the shapeshifting particles have a first set of spatial dimensions corresponding to a first conformation at the first set of conditions and a second set of spatial dimensions corresponding to a second conformation at a second set of conditions, wherein the second set of spatial dimensions comprises at least one dimensional characteristic or aspect ratio that is substantially different than the corresponding dimensional characteristic or aspect ratio of the first conformation.

14. The treatment fluid of claim 13, wherein the shapeshifting particles comprise fibers, ribbons, flakes, films, sheets, platelets, or a combination thereof, having an aspect ratio of greater than or equal to about 6.

15. The treatment fluid of claim 13, wherein the shapeshifting particles are shrinkable fibers.

16. The treatment fluid of claim 13, wherein the shapeshifting particles are degradable.

17. The treatment fluid of claim 13, wherein the shapeshifting particles comprise a polyester, a polyamide, a polyolefin, or a combination thereof.

18. The treatment fluid of claim 13, wherein the shapeshifting particles comprise polylactic acid, polyglycolic acid, polyethylene terephthalate, poly(hydroxyalkanoate), nylon 6, nylon 6,6, nylon 6,12, polyethylene, polypropylene, polystyrene, poly(ethylene vinyl acetate), polyvinyl alcohol, 2-acrylamido-2-methylpropane sulfonic acid, or copolymers thereof.

19. The treatment fluid of claim 13, wherein the shapeshifting particles comprise fibers having a sheath comprising a first component disposed around a core comprising a second component different from the first component.

20. The treatment fluid of claim 19, wherein the first component and the second component have different crystallinities, different coefficients of thermal expansion, or a combination thereof.

21. The treatment fluid of claim 13, wherein the shapeshifting particles comprise a shrinkable film.

22. The treatment fluid of claim 21, wherein the shrinkable film comprises a polyurethane, two or more dissimilar layers, or a combination thereof.

23. The treatment fluid of claim 13, wherein the shapeshifting particles are fibers selected from the group consisting of eccentric or concentric side-by-side multicomponent fibers, islands-in-the-sea multicomponent fibers, segmented-pie cross-section type multicomponent fibers, radial type multi-component fibers, core-sheath multicomponent fibers, and a combination thereof.

24. The treatment fluid of claim 13, wherein the proppant particles have an aspect ratio less than 2.

25. A system to treat a subterranean formation, comprising:
a subterranean formation penetrated by a wellbore;
a treatment fluid supply unit to supply a treatment fluid comprising proppant particles and shapeshifting particles dispersed in a carrier fluid at a first set of conditions, wherein the shapeshifting particles have a first set of spatial dimensions corresponding to a first conformation at the first set of conditions and a second set of spatial dimensions corresponding to a second conformation at a second set of conditions, wherein the second set of spatial dimensions comprises at least one dimensional characteristic or aspect ratio that is substantially different than the corresponding dimensional characteristic or aspect ratio of the first conformation;
a pump system to continuously deliver the treatment fluid from the supply unit through the wellbore to the formation at a pressure above fracturing pressure to inject the treatment fluid into a fracture in the formation; and
a triggering system to change the first set of conditions from the treatment fluid supply unit to the second set of conditions in the fracture.

26. The system of claim 25, further comprising a shut-in system to maintain and then reduce pressure in the fracture.
